(19) United States
(12) Patent Application Publication
(10) Pub. No.: US 2014/0252774 A1
(43) Pub. Date: Sep. 11, 2014

(54) WIND, SOLAR, AND MAGNETIC ELECTRICAL GENERATION SYSTEM

(71) Applicant: Paul Boaventura-Delanoe, (US)

(72) Inventors: Paul Boaventura-Delanoe, Los Angeles, CA (US); Larry Cantwell, Amargosa Valley, NV (US); Armen M. Showalter, Indian Valley, VA (US)

(21) Appl. No.: 13/999,790

(22) Filed: Mar. 21, 2014

Related U.S. Application Data
(60) Provisional application No. 61/755,950, filed on Jan. 23, 2013.

(51) Int. Cl. F03D 9/00; H02K 47/04

(52) U.S. Cl. CPC F03D 9/007; F03D 9/003; H02K 47/04
USPC 290/55; 310/113

(57) ABSTRACT

The invention provides a system, apparatus and method for generating continuous electricity from a variety of sources, using high torque, high efficiency motors, and optionally a wind turbine to operate at least one generator.

### CLAIM OF PRIORITY

This application claims the benefit of Provisional patent Application Ser. No. 61/728,201 filed Jan. 23, 2103, the entirety of which is hereby incorporated herein by reference.

### FIELD OF THE INVENTION

The present disclosure is directed to devices and systems for producing electricity by operating an electric generator using a combination of different energy forces, and more particularly to using wind and high torque motors to operate the generator.

### BACKGROUND OF THE INVENTION

Electricity has historically been produced by using photovoltaic solar panels to convert the energy from the sun to electricity, natural hydro power from rivers, streams or the oceans to turn turbines, fossil fuels to heat water that uses the steam to turn the turbines, or nuclear power to heat water to turn the turbines. The turbines that produce the electricity have used the same basic principles for the last 150 years. One embodiment of this invention uses a motor powered by manufactured wind to mechanically turn the turbines that will produce electricity. The motors used in this invention can be variations of conventional electric motors to produce electricity, switched reluctance motors/generators or permanent magnet motors/generators.

There is a need to efficiently produce electricity without the use of fossil fuels to produce clean, green electricity which can be consumed on site, or fed into an electricity grid to be distributed to other users.

Other methods of producing electricity use fossil fuels which are damaging to the environment or have very harmful byproducts such as CO2, spent nuclear fuel rods, coal ash, and other byproducts.

Photovoltaic solar panels work at less than 20% efficiency and only produce electricity when the sun is shining directly on the panels. The farther away from the equator, the less efficient the solar panels act to produce electricity. This equates to annual average electricity production of less than 5 hours per day. Wind to turn the turbines is determined by the geography and is generally not available near where the electricity is consumed. The best natural wind locations typically only produce energy 8 hours per day.

### SUMMARY OF THE INVENTION

The present invention provides clean generation and efficient storage of electricity, which results in a significant decrease in environmental impact and other advantages apparent from the discussion herein.

In an embodiment of the invention, a system for generation of continuous electricity is provided and includes at least one generator to produce a continuous supply of AC or DC electricity, at least one motor that operates at from approximately 1500 to approximately 1800 rpm, without surges or power drains, operatively connected to the generator to regulate the speed of the generator, at least one energy storage device to store electricity and to provide electricity to the at least one motor, and a source of energy operably coupled to the energy storage device. The system of the invention may further include at least one wind turbine operably coupled to the at least one generator to operate the generator to produce electricity, and a source of wind to operate the wind turbine. In a system of the invention, the source of wind is at least one blower component operably connected to a motor that operates at approximately 4000 rpm. In a system of the invention, at least one motor is a high torque switch reluctance motor that operates at from approximately 1500 rpm to approximately 1800 rpm.

The system of the invention may also include an output quality rectifier component that is electrically connected to the at least one generator.

In the system of the invention, the at least one energy storage device may include at least one battery that is simultaneously charged and discharged and may be a lithium ion battery. The system may include multiple batteries connected in series and in parallel to continuously charge and discharge electricity. DC electricity produced by the generator may be converted into AC electricity.

The system of the invention may further include at least two generators and at least two motors for operating the generators. The system may further include an inverter electrically coupled to the generator via a DC bus for converting DC electricity to AC electricity.

In the system of the invention the source of energy is selected from the group consisting of solar panels, wind turbines, magnetic flywheels and DC generators.

In the system of the invention including a wind turbine, the wind turbine includes a vortex wind tube housing, and a wind inlet port and a wind exhaust port, and a plurality of blades having at least one wind catching surface, the blades centrally positioned inside of the vortex wind tube housing to present the wind catching surface to wind entering the inlet port to move the blades, the blades operably connected to a shaft, to rotate the shaft when the blades are moved by the wind.

An embodiment of the invention is a wind turbine including a vortex wind tube housing having an inner curved channel and an outer curved channel in the interior of the housing, and having a wind inlet port and a wind exhaust port and a central opening for the shaft, and having a plurality of blades each having at least one wind catching surface, the blades centrally positioned inside of the vortex wind tube housing to present the wind catching surface of each blade to wind entering the inlet port to move the blades, the blades operably connected to a shaft in the central opening of the vortex wind tube housing to rotate the shaft when the blades are moved by the wind. The wind turbine may further include at least one wind deflecting component attached to an inner surface of the vortex wind tube housing to deflect incoming wind moving in the outer channel of the circular housing into the inner channel to contact the wind catching surfaces of the blades. The wind turbine may further include a rotating plate attached to the plurality of blades, the plate attached to the shaft, to rotate the shaft when the blades are moved by the wind.

In an embodiment of the invention, a system is provided for supplying continuous electricity to an energy grid that includes a plurality of electrically connected units, each unit including at least one generator to produce a continuous supply of AC or DC electricity, at least one motor that operates without surges or power drains to produce continuous power to operate the generator and to regulate the speed of the generator at approximately 1500 to approximately 1800 rpm, at least one energy storage device to store electricity and to provide electricity to the at least one motor, a source of energy operably coupled to the energy storage device; and an electrical combining component to collect and combine the energy for each unit into a transformer to feed the energy into an existing energy grid. The system may include at least one wind turbine coupled to the one generator to produce electricity, and a source of wind to operate the wind turbine.

A method of the invention for generation of continuous AC or DC electricity includes operating at least one generator by at least one high torque motor that operates at from approximately 1500 rpm to approximately 1800 rpm, without surges or power drains, operatively connected to the generator, to regulate the speed of the generator, the motor powered by at least one energy source. The method may include a wind turbine to operate the generator.

Additional features, advantages, and aspects of the present disclosure are set forth or apparent from consideration of the following detailed description, drawings, and claims. Moreover, it is to be understood that both the foregoing summary of the present disclosure and the following detailed description are exemplary and intended to provide further explanation without limiting the scope of the present disclosure as claimed.

### BRIEF DESCRIPTION OF THE DRAWINGS

The accompanying drawings, which are included to provide a further understanding of the present disclosure, are incorporated in and constitute a part of this specification, illustrate aspects of the present disclosure and together with the detailed description serve to explain the principles of the present disclosure. No attempt is made to show structural details of the present disclosure in more detail than may be necessary for a fundamental understanding of the present disclosure and the various ways in which it may be practiced. In the drawings:

FIG. 1 is a diagram of the components of an embodiment of a system of the invention;

FIG. 2 is a view of one side of an embodiment of a system of the invention;

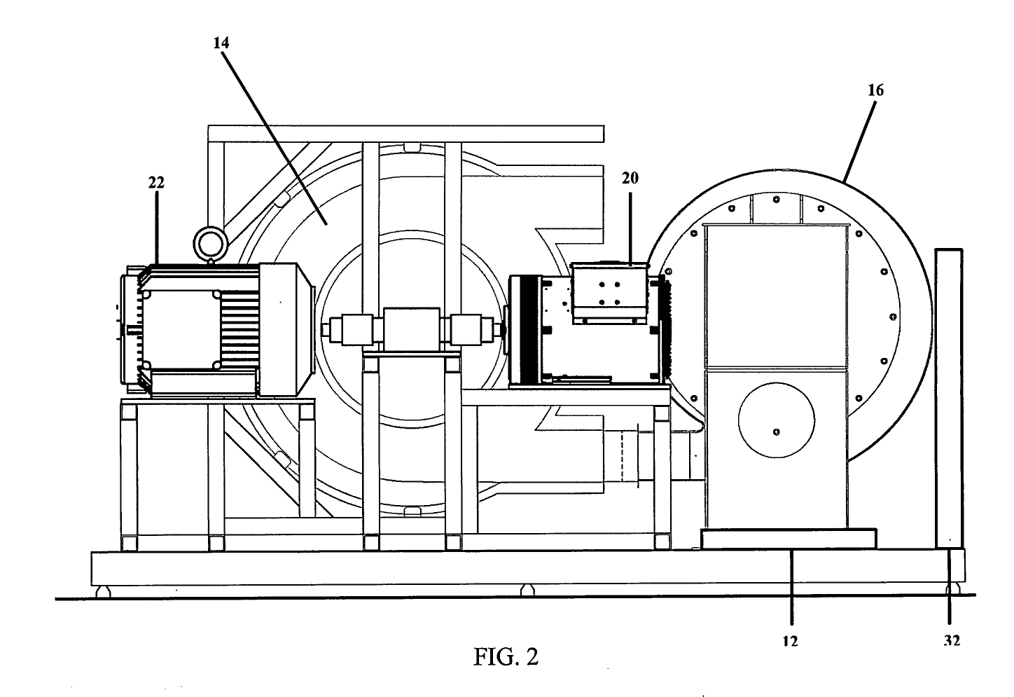

FIG. 3 depicts a perspective and transparent view of the wind turbine according to an embodiment of the invention; and

FIG. 4 shows a cross-section of the wind turbine depicted in FIG. 3 taken along line 4-4, in a vertical position, according to an embodiment of the invention.

### DETAILED DESCRIPTION OF THE INVENTION

The aspects of the present disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the present disclosure. The examples used herein are intended merely to facilitate an understanding of ways in which the present disclosure may be practiced and to further enable those of skill in the art to practice the aspects of the present disclosure. Accordingly, the examples and aspects herein should not be construed as limiting the scope of the present disclosure, which is defined solely by the appended claims and applicable law. Moreover, it is noted that like reference numerals represent similar parts throughout the drawings.

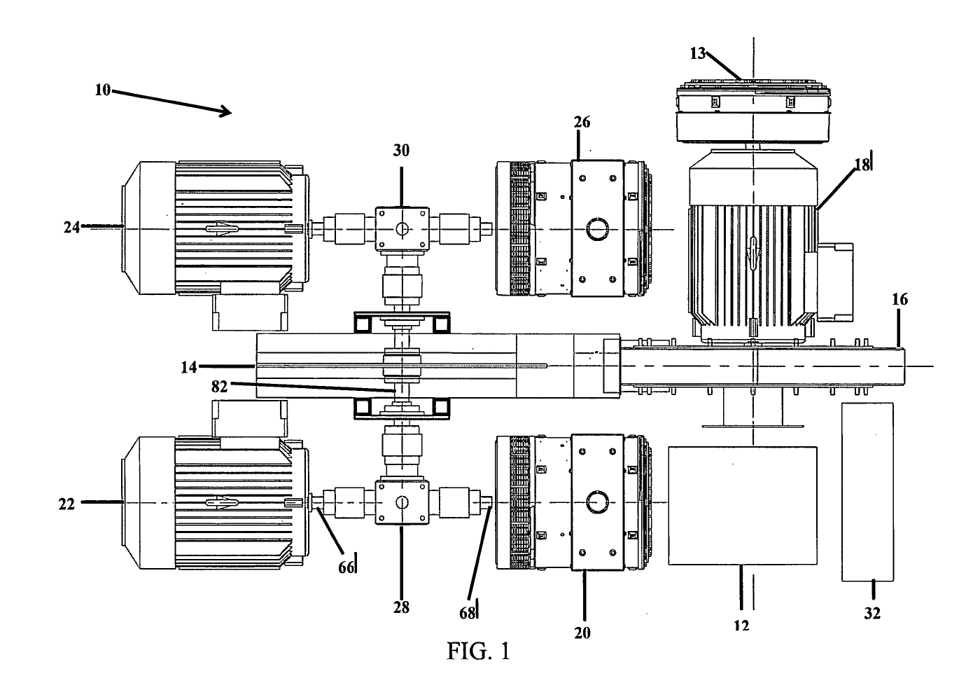

According to an aspect of the present disclosure, referring to FIG. 1, an embodiment of the system 10 of the invention includes at least energy storage device 12 to supply and store AC or DC electricity. The source of electricity for the energy storage device 12 may be solar photovoltaic panels, natural wind, a magnetic flywheel, a DC generator 13, or any other source of power to generate electricity. In one aspect of the present disclosure, the storage device 12 may contain one or more batteries, such as lithium ion batteries. The batteries may be connected together in a serial and parallel manner that allows the batteries to continuously charge and discharge electricity to provide a supply of electricity at the appropriate voltage and amperes to power motors 18, 22 and 24. However, any battery method or storage device 12 may be used to store electricity for use later.

The system 10 may include at least one wind turbine 14 that may be powered by natural wind or at least one blower 16 that produces manufactured wind, to which the wind turbine 14 is operably connected. The blower 16 is powered by a blower motor 18 powered by the at least one battery 12, which may be a high torque switch reluctance motor that operates at from approximately 1550 to approximately 1800 rpms, without surges or power drains and that regulates the speed of the wind turbine to maintain it at a constant speed. The wind turbine 14 is operably connected to and operates at least one generator 20 to produce AC or DC electricity. The generator 20 is also operated by a motor 22, that may be a high torque switch reluctance motor that operates at from approximately 1500 to approximately 1800 rpms, without surges or power drains to regulate the speed of the generator. As shown in FIG. 1, additional high torque motors, and generators, such as motor 24 and generator 26, may be used in the system 10, to generate a continuous supply of AC or DC electricity. The motors 22 and 24 and the wind turbine 14 are operably connected to gear boxes 28 and 30 which are operably connected to the generators 20 and 26. “Operably connected” means electrically or structurally connected, for example by electrical wiring, or by rotating a shaft to generate electricity. An energy output rectifier component 32 may be used to modulate the output of the AC or DC electricity produced by the system 10.

In one embodiment the high torque motors 18, 22 and 24, operate at from approximately 1500 rpm to approximately 1800 rpm, and are operably connected to the generators 20, 26 and to regulate the speed of the generator(s) 20, 26 and are operably connected to the blower 16 and operate at approximately 4000 rpm to regulate the wind turbine 14 at a constant speed, as the generator(s) 20, 26 are subject to application of and removal of load, and to operate the wind turbine 14 when wind is provided by the blower 16. The motors 18, 22 and 24, can be any high torque motor that reduces the counter electromotive force (CEMF) by maximally saturating the motor coils and optimally at high motor loads, requiring less energy to operate the motor, without surges or power drains. The motors may consist of four rotors and six stators, or other combinations. A suitable motor is the switch reluctance motor available from Agni Motors, India (www.agnimotors.com) and EON Electric Motors (www.eon-electric.kn Sao Paulo, Brazil) having a rotor plate having four poles, and a stator plate having six poles.

The motor 22 has a shaft 66 that is operably coupled to gearbox 28 which also has a shaft 68 operably coupled to generator 20 to turn generator 20 to produce electricity. The motor 22 may be encased in a housing.

The electricity that is produced by the generators 20, 26 and 13 of the system 10 of the invention may be AC or DC electricity, e.g., in the range of approximately 100 volts to approximately 480 volts for AC, or from approximately 12 to approximately 100 volts DC. The electricity may be high amperage, e.g., from at least approximately 20 to approximately 600 amperes. This electricity may be transferred into, e.g., energy storage device 12 containing multiple batteries. The energy storage device 12 may be used to power the blower motor 18 for the wind turbine 14, and the switch reluctance motor(s) 22 and 24. Output from the energy storage device 12 may be directed to the energy output rectifier component 32 to produce synchronized, usable AC or DC electricity.

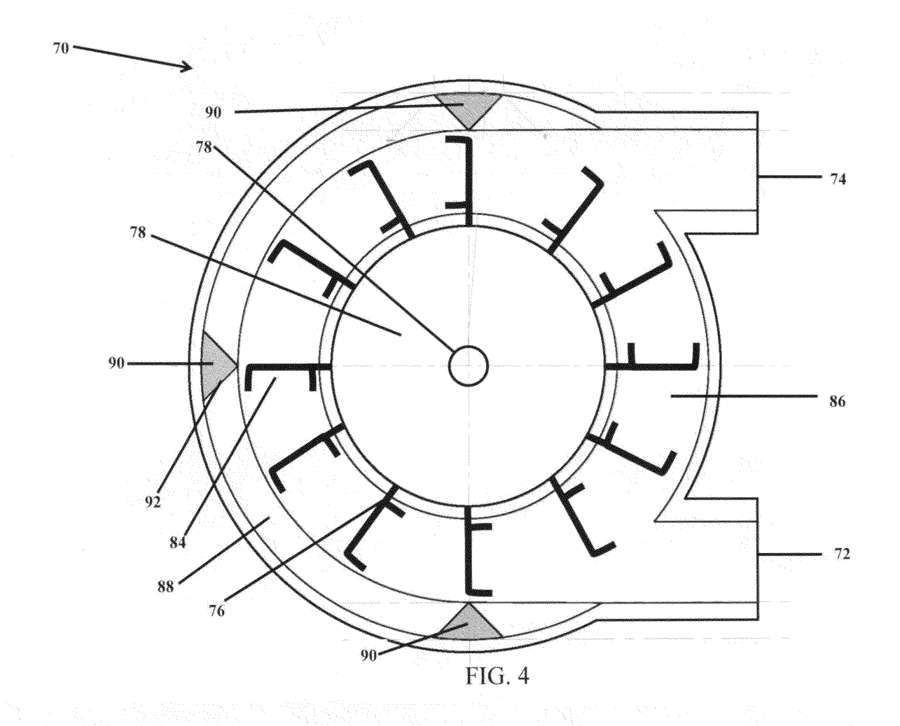

The size and the configuration of the blower 16 needed to produce the manufactured wind may be determined by the force needed to turn the blades 76 in the vortex wind tube housing 70 of the wind turbine component 14, as shown in FIG. 4. The force needed to turn the blades 76 may depend on the torque needed to turn the generators 20 and 26.

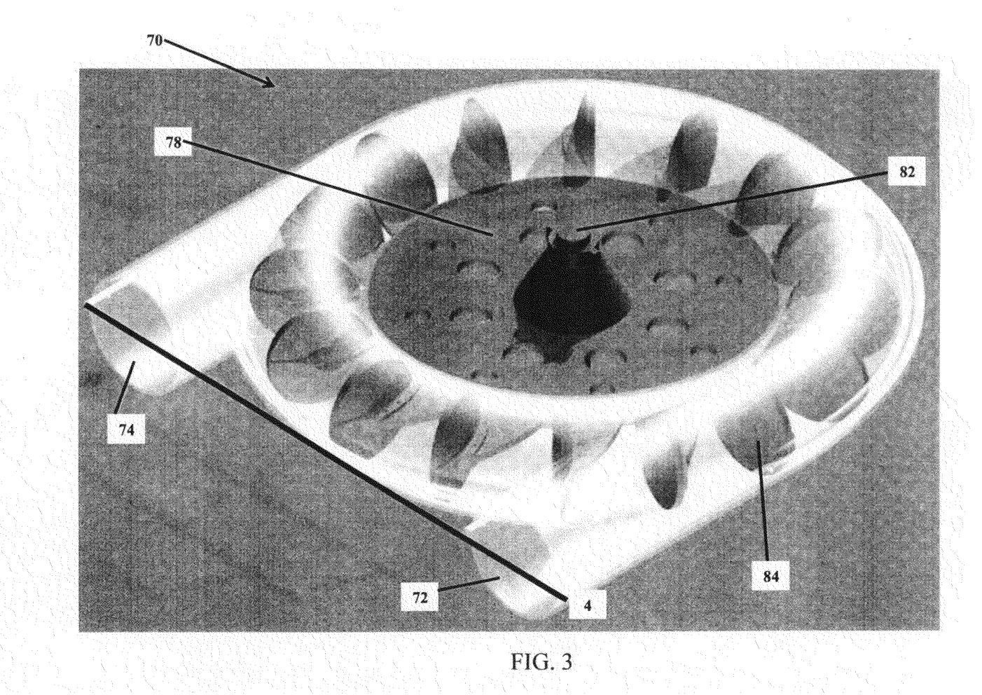

Referring to FIGS. 1, 3 and 4, according to an aspect of the present disclosure, a wind turbine component 14 may include a circular hollow vortex wind tube housing 70 made of fiberglass, metal, plastic or any other composite material and having inlet port 72 and exhaust port 74. Wind is compressed and rotated within the wind tube housing 70 to apply pressure to the blades 76. The vortex wind tube housing 70 may be positioned horizontally within a frame to hold the apparatus steady, or the tube housing 70 may be positioned in a non-horizontal position, for example upright or vertical. A plurality of round, flat or conical, or concave blades 76, or blades having other shapes and sizes, may be attached to a central plate 78, having an opening 80 for a shaft 82. The central plate 78 is attached to the shaft 82. Natural wind or manufactured wind from blower 16 entering the wind tube housing 70 (FIG. 4) through inlet port 72 contacts a wind catching surface 84 of blades 76 moving the blades 76 and plate 78 and rotates shaft 82 to turn gearbox 28 which turns shaft 68 of generator 20 producing electricity. The vortex wind tube housing 70 may include an inner curved channel 86 and an outer curved channel 88, and at least one deflector 90. Incoming wind moving in outer channel 88 contacts a surface 92 of deflector 90 and is deflected into inner channel 86. Use of a deflector 92 rechannels wind travelling in the outer channel 88 of the vortex wind tube housing 70 to contact the plurality of blades 76, resulting in faster revolution of the plurality of blades 76 which provides increased power to the generator 20 and 26 and greater efficiency.

According to an exemplary design, the outer diameter of the vortex wind tube housing 70 may be approximately 38 inches and the diameter of the plate 78 may be approximately 25 inches minus the thickness of the material used in the plate 78. The size and dimensions of the tube housing 70 and blades 76 may be adjusted or altered according to a particular application, as will be apparent to those skilled in the art. The blades 76 may have a concave shape, but a reverse cone or any other shape that will cause the blades 76 to move optimally within the wind tube housing 70 may be used. The plate 78 having the blades 76 attached may spin the shaft 82 at a desired speed, such as, from approximately 1500 to approximately 1800 revolutions per minute. Electrical generator 20 may be connected to the shaft 82 attached to the plate 78 in the center of the wind tube housing 70. As the blades 76 turn, the vertical shaft 82, the vertical shaft 82 rotates a shaft 84 in the generator 20, thereby producing electricity.

As shown in FIG. 1, the electricity produced by generators 20 and 26, may be fed into an energy output quality rectifier component 32, which may include a series of electrical capacitors, inverters, and regulators to synchronize the electricity into a usable product of voltage, amperage, wattage, Hz and sine waves. An example of a suitable rectifier component is available from Endelos Power, Buellton, Calif. The electricity may be consumed, fed into a power grid for example a utility company power grid providing power for a community, or stored until needed. Safety components, such as an automatic and manual shut off device in the energy output quality rectifier component 32, may be used to prevent feeding electricity into the grid in the event of an electrical blackout.

Electrical production from DC generator 13 may be diverted back to the energy storage device 12. The electrical generation system 10 of the invention may use natural energy sources such as solar photovoltaic panels and/or natural wind power, or other sources, such as batteries, to provide the electricity for operating at least one motor to operate the at least one generator for producing AC or DC electricity. Natural sources of power may only be available for limited periods of time. The electricity from the generators 20 and 26 as depicted in the embodiment shown in FIG. 1 in the system 10 of the invention may be stored in an energy storage device 12, for example, a lithium ion battery “brick,” such as is available from BMZ USA, Inc., Virginia Beach, Va. (www.bmz-usa.com). The energy storage device 12 may be configured to allow simultaneous charging and discharging. Power from the energy storage device 12, which may be available as stored electricity, even when power from natural sources is not, may be used to power one or more blowers 16. The blower 16 may be used to produce manufactured wind, and the manufactured wind may turn blades 76 in a vortex wind tube housing 70 in wind turbine component 14. The wind turbine component 14 may include a deflector 90 to recycle and redirect excess wind. By recycling the wind in a constantly moving fashion, the wind turbine 14 may gain the benefit or effect of rotational energy. The central shaft 82 of the wind turbine component 14 may be connected to a shaft 68 of electrical generator 20. Output from the electrical generator 20 may be fed into the energy output quality rectifier component 32, which may include a series of regulators, inverters, and capacitors to synchronize the harmonics of the sine waves, voltage, and amperes to produce clean, useable energy.

The system of the invention may include multiple units electrically coupled to least one other unit, each unit consisting of at least one generator to produce a continuous supply of AC or DC electricity, at least one motor that operates without surges or power drains to produce continuous power to operate the at least one generator, that regulates the speed of the generator from approximately 1500 to approximately 1800 rpm, at least one energy storage device to store electricity and to provide electricity to the at least one motor, and an electrical combining component to collect and combine the energy from each unit into a transformer to feed the energy into an existing energy grid.

While the present disclosure has been described in terms of exemplary aspects, those skilled in the art will recognize that the present disclosure can be practiced with modifications in the spirit and scope of the appended claims. These examples and embodiments given above are merely illustrative and are not meant to be an exhaustive list of all possible designs, aspects, applications or modifications of the present disclosure. Multiple high torque motors powered by a battery or other energy source, may be used to operate multiple AC or DC generator and blowers. Moreover, multiple systems consisting of electrically coupled systems of the invention may be used to provide electricity to supplement power provided by, for example, utility stations that provide electricity to end users.

What is claimed is:

1. A system for generation of continuous electricity comprising:
a) at least one generator to produce a continuous supply of AC or DC electricity;
b) at least one motor that operates at from approximately 1500 to approximately 1800 rpm, without surges or power drains, operatively connected to the generator to regulate the speed of the generator;
c) at least one energy storage device to store electricity and to provide electricity to the at least one motor; and
d) a source of energy operably coupled to the energy storage device.

2. The system of claim 1, further comprising at least one wind turbine operably coupled to the at least one generator to operate the generator to produce electricity; and a source of wind to operate the wind turbine.

3. The system of claim 2, wherein the source of wind is at least one blower component operably connected to a motor that operates at approximately 4000 rpm.

4. The system of claim 3, wherein the at least one motor is a high torque switch reluctance motor.

5. The system of claim 1, further comprising an output quality rectifier component that is electrically connected to the at least one generator.

6. The system of claim 1, wherein the at least one energy storage device comprises at least one battery that is simultaneously charged and discharged.

7. The system of claim 6, wherein the at least one battery comprises a lithium ion battery.

8. The system of claim 6, comprising multiple batteries connected in series and in parallel to continuously charge and discharge electricity.

9. The system of claim 1, wherein DC electricity produced by the generator is converted into AC electricity.

10. The system of claim 1, comprising at least two generators and at least two motor for operating the generators.

11. The system of claim 1, further comprising an inverter electrically coupled to the generator for converting DC electricity to AC electricity.

12. The system of claim 1, wherein the source of energy is selected from the group consisting of solar panels, wind turbines, magnetic flywheels and DC generators.

13. The system of claim 2, wherein the wind turbine comprises:
a) a vortex wind tube housing having a wind inlet port and a wind exhaust port; and
b) a plurality of blades having at least one wind catching surface, the blades centrally positioned inside of the vortex wind tube housing to present the wind catching surface of each blade to wind entering the inlet port to rotate the blades, the blades operably connected to a shaft, to rotate the shaft when the blades are moved by the wind.

14. A wind turbine comprising:
a) a vortex wind tube housing having an inner curved channel and an outer curved channel with said housing;
b) the vortex wind tube housing having a wind inlet port and a wind exhaust port and a central opening for a shaft; and
c) a plurality of blades each having at least one wind catching surface, the blades centrally positioned inside of the vortex wind tube housing to present the wind catching surface of each blade to wind entering the inlet port to move the blades, the blades operably connected to a shaft in the central opening of the vortex wind tube housing to rotate the shaft when the blades are moved by the wind.

15. The wind turbine of claim 14, further comprising at least one wind deflecting component attached to an inner surface of the vortex wind tube to deflect incoming wind moving in the outer channel of the circular housing into the inner channel to contact the wind catching surfaces of the blades.

16. The wind turbine of claim 14, further comprising at rotating plate attached to the plurality of blades, the plate attached to the shaft, to rotate the shaft when the blades are moved by the wind.

17. A system for supplying continuous electricity to an energy grid comprising a plurality of electrically connected units, each unit comprising:
a) at least one generator to produce a continuous supply of AC or DC electricity;
b) at least one motor that operates without surges or power drains to produce continuous power to operate the generator and to regulate the speed of the generator at approximately 1500 to approximately 1800 rpm;
c) at least one energy storage device to store electricity and to provide electricity to the at least one motor; and
d) a source of energy operably coupled to the energy storage device; and
e) an electrical combining component to collect and combine the energy for each unit into a transformer to feed the energy into an existing energy grid.

18. The system of claim 17, further comprising at least one wind turbine coupled to the at least one generator to produce electricity; and a source of wind to operate the wind turbine.

19. A method for generation of continuous AC or DC electricity comprising operating at least one generator by at least one high torque motor that operates at from approximately 1500 rpm to approximately 1800 rpm, without surges or power drains, operatively connected to the generator, to regulate the speed of the generator, the motor powered by at least one energy source.

20. The method of claim 19, further comprising a wind turbine to operate the generator.
